(19) United States
(12) Patent Application Publication
(10) Pub. No.: US 2009/0226684 A1
(43) Pub. Date: Sep. 10, 2009

(54) Printable Composition Containing Carbon Nanotubes, Processes for Their Preparation and Electrically Conductive Coating Prepared Therefrom

(75) Inventors: Stefan Bahnmuller, Singapore (SG); Stefanie Eiden, Leverkusen (DE); Olaf Behrend, Koln (DE); Diana Dimova Landen, Leverkusen (DE); Matthias Boll, Koln (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/370,643

(22) Filed: Feb. 13, 2009

(30) Foreign Application Priority Data
Feb. 13, 2008 (DE) 102008008837.4

(51) Int. Cl. H01B 1/24; B05D 5/12; B32B 3/00

(52) U.S. Cl. 428/206; 252/511; 427/98.4; 977/742

(57) ABSTRACT

Aqueous, printable compositions comprising carbon nanotubes and a polymeric dispersing agent, wherein at least one fifth of the carbon nanotubes have a molecular structure comprising a plurality of stacked and rolled graphene layers; processes for preparing such compositions, methods of use and electrically conductive coatings prepared therewith.

### BACKGROUND OF THE INVENTION

Surfaces with electrically conductive properties are widely distributed in economic applications, for example in the manufacture of electrical switching circuits, sensors and heating coils.

In this context, the traces are applied on to the surface by means of various processes. It is common to the known products, however, that the resulting conductive properties are based on metallic or semiconductive coating materials.

Essential to the aforementioned products is their generally high degree of distribution. The materials and processes used must therefore enable the resulting component to be produced at the lowest possible costs in order to meet the high demand cheaply. Processes that make this possible are e.g. the common screen-printing processes for the production of electrically conductive coatings.

This requirement leads to the fact that the use of metallic conductors, particularly of precious metals, on components in some areas of application is disadvantageous, particularly from the point of view of price. Applications that have become known fairly recently are, for example, so-called “Radio Frequency Identification” tags (RFID tags for short). These are passive or active electronic components which are substantially used for the storage and transfer of data relating to the object on which they are located.

Studies exist according to which, in 2008 in Europe alone, out of 260 billion individual products, as many as 5% (i.e. 13 billion) are said to be fitted with one of these components. (Press release, “Enorme Wachstumsraten für RFID-Markt in Europa” [“Enormous growth rates for RFID market in Europe”], SOREON Research GmbH, Frankfurt am Main, 10 May 2004).

Among other things it is conceivable that, for many of these products, the component is applied to a package which must be disposed of after the product it contains has been used. Consequently, metallic conductors or semiconductor products are disadvantageous in disposal since they are difficult to incinerate completely. On the other hand, components largely consisting of readily combustible substances would offer an advantage here. Suitable examples of these would be conductive pastes or inks based on carbon black or graphite, or the special carbon nanotubes presented in this invention.

A prerequisite for the good electrical conductivity of the coatings is a fine dispersion of the conductive particles in the formulations used for the coating in each case and a high specific conductivity thereof.

In U.S. Pat. App. Pub. No. US 2006/124028 A1, an ink is disclosed for such a purpose which employs carbon nanotubes for use in ink jet printers. The ink is characterized by a surface tension of 0.02-0.07 N/m and a viscosity of 0.001-0.03 Pa.s at 25° C. The content of carbon nanotubes is disclosed within broad limits as 0.1-30 wt. %. The inks are not suitable for screen printing, with a viscosity of up to 0.03 Pa.s. A viscosity of the order of magnitude of 1 Pa.s would be needed for this purpose.

In U.S. Pat. App. Pub. No. US 2005/284232 A1, an electrically conductive coating which contains carbon nanofibres is disclosed. The coating is intended to be applied by brushing, rolling or spraying an appropriate ink. The use of the ink for screen printing is not disclosed. The ink has a content of carbon nanofibres of 4-12 wt. % in a matrix similar to the substrate, here for example urethanes, polyimides, cyanate esters and other organics. No disclosure is given relating to the parameters relevant to screen printing, such as, e.g., surface tension on a certain substrate or viscosity. It is disclosed that the viscosity can be reduced by dissolving the matrix.

In International Pat. Pub. No. WO 2005/119772 A2, an ink is disclosed comprising carbon nanotubes, wherein the carbon nanotubes used have an external diameter of no more than 20 nm and are used in a concentration of ≦10 wt. %. The post-treatment temperature is disclosed as greater than 75° C., and this should last for at least 10 minutes. In addition, compositions of an ink for use e.g. in screen printing are disclosed, which use derivatives of cellulose, among other things, to achieve or obtain dispersion in the resulting formulation. The resulting surface resistance of the inks after treatment according to the disclosure is a maximum of 10 kΩ/m.

In International Pat. Pub. No. WO 2005/029528 A1, inks or pastes comprising carbon nanotubes are disclosed, which are applied on to surfaces by various printing techniques (e.g. screen printing) for the purpose of producing electrodes. The inks disclosed are either aqueous formulations comprising carbon nanotubes with inorganic auxiliary agents, or formulations in organic solvents comprising carbon nanotubes with organic, polymeric auxiliary agents. The carbon nanotubes used are the types generally known to the person skilled in the art. The physical properties of the inks with respect to viscosity, surface tension and conductivity are not disclosed. The inks disclosed are disadvantageous since they are either present in organic solvents and thus are potentially an environmental risk, or they comprise inorganic auxiliary agents, such as Al₂O₃ or SiO₂, which are non-conductive and are also not easy to remove in the course of a post-treatment. It can therefore be assumed that the conductivity of the printed image is disadvantageous compared with an ink without these auxiliary agents.

In the prior art set out above, carbon nanotubes of the cylinder type are always used for the production of inks. These carbon nanotubes are structures of either single wall (so-called “single wall carbon nanotubes”—SWNTs—) or multiwall (so-called “multi wall carbon nanotubes”—MWNTs—) carbon nanotubes, as described e.g. in the publication by Ijima (publication: S. Ijima, NATURE Vol. 354, pp. 56-58, 1991). These known carbon nanotubes are characterised by structures of carbon tubes in which one or more closed, concentrically arranged graphene layers form the basis of the structure of the nanotubes.

### BRIEF SUMMARY OF THE INVENTION

The present invention relates, in general, to inks (also referred to herein as “printable compositions”) for the production of conductive printed images based on carbon nanotubes and at least one polymeric dispersing agent in an aqueous formulation and a process for the preparation thereof.

Various embodiments of the present invention provide inks comprising special carbon nanotubes, which are highly suitable for industrial-scale printing processes, such as e.g. screen printing, and exhibits improved conductivities compared with the prior art and is environmentally sound.

Surprisingly, it has been found that such properties and advantages can be achieved by an ink for the production of conductive printed images, which contain a certain proportion of special carbon nanotubes that have a previously undescribed internal structure of several graphene layers which are collected into a stack and rolled up (multi-scroll type), and comprise a proportion of at least one polymeric dispersing agent in an aqueous formulation.

The present invention provides a printable composition for the production of electrically conductive coatings based on carbon nanotubes and at least one polymeric dispersing agent in an aqueous formulation, characterised in that at least one fifth of the carbon nanotubes consist of carbon nanotubes which have a molecular structure with several graphene layers which are collected into a stack and rolled up (multi-scroll type).

One embodiment of the present invention includes aqueous, printable compositions comprising carbon nanotubes and a polymeric dispersing agent, wherein at least one fifth of the carbon nanotubes have a molecular structure comprising a plurality of stacked and rolled graphene layers.

Another embodiment of the present invention includes processes comprising: (i) providing a polymeric dispersing agent; (ii) providing carbon nanotubes, wherein at least one fifth of the carbon nanotubes have a molecular structure comprising a plurality of stacked and rolled graphene layers; (iii) combining the polymeric dispersing agent, the carbon nanotubes and an aqueous medium to form an aqueous, printable composition.

In connection with the present invention, the term printed images refers to structures on surfaces, which have been applied to the surface by means of a generally known printing technique. Printed images thus also include traces that have been applied to surfaces by means of a printing technique. The term should therefore not be understood in a restrictive manner in terms of its creative aspect.

Special carbon nanotubes of the multi-scroll type refer to carbon nanotubes and agglomerates thereof, as provided e.g. in U.S. patent application Ser. No. 12/208,468 (corresponding to German Patent Application No. DE102007044031.8), the entire contents of which are hereby incorporated by reference herein. The content thereof in respect of the carbon nanotubes and their preparation is hereby included in the disclosure content of this application. The special carbon nanotubes of the multi-scroll type can be used in a mixture with other types of carbon nanotubes that are known per se, namely single wall CNTs and/or multi-wall CNTs.

Unlike known CNT structures, the individual graphene or graphite layers in these special carbon nanotubes seen in cross section run continuously from the centre of the carbon nanotubes to the outer edge without interruption. This can make possible e.g. an improved and more rapid intercalation of other materials in the tube structure, since more open edges are available as an entry zone for the intercalates than in comparison to known carbon nanotubes.

Surprisingly, as a result of these properties in combination with the polymeric dispersing agent, the good dispersibility and homogeneity of the resulting ink is achieved. The term ink is also used below for the sake of simplicity instead of the term printable composition.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a polymeric dispersing agent” herein or in the appended claims can refer to a single polymeric dispersing agent or more than one polymeric dispersing agent. Additionally, all numerical values, unless otherwise specifically noted, are understood to be modified by the word “about.”

The carbon nanotubes may be present in the ink according to the invention in treated or untreated form. If they are treated, they have preferably been previously treated with an oxidizing agent. The oxidizing agent is preferably nitric acid and/or hydrogen peroxide, and the oxidizing agent is particularly preferably hydrogen peroxide.

A composition with carbon nanotubes which have a length to external diameter ratio of more than 5, preferably more than 100, is preferred.

The carbon nanotubes used preferably have an average external diameter in this case of 3 to 100 nm, particularly preferably of 5 to 80 nm, most particularly preferably of 6 to 60 nm.

The special carbon nanotubes are generally present in the ink according to the invention at least partly as agglomerates. Preferably less than 15 number % of the carbon nanotubes are present as agglomerates. Particularly preferably less than 5 number % of the carbon nanotubes are present as agglomerates.

If the carbon nanotubes are present in the ink as agglomerates, these preferably have a diameter substantially of ≦5 μm, particularly preferably ≦3 μm. Most particularly preferably the agglomerate diameter is ≦2 μm.

A small proportion of the smallest possible agglomerates is advantageous, because as a result of this, the physical properties of viscosity and conductivity of the ink, as well as its processability when used according to the invention, are improved. Coarse and numerous agglomerates may in certain circumstances lead to clogging of the printing equipment during printing. In addition, coarse and numerous agglomerates may lead to areas of the printed image that possess high conductivity while other areas have no, or only very low, conductivity. Since it is generally known to the person skilled in the art that the combined resistance of an electrical trace is obtained from a series connection of its individual resistances, the resistance of the overall trace is therefore disadvantageously high if such an inhomogeneous resistance distribution is produced by too numerous and too coarse agglomerates.

The preferred length to external diameter ratio and the average external diameter of the carbon nanotubes guarantee the high specific conductivity of the resulting ink, since this, together with the close contact in the agglomerates that are present, enables good percolation of the conductive layer to be achieved.

The proportion of carbon nanotubes in the ink is generally from 0.1 wt. % to 15 wt. %. The proportion of carbon nanotubes in the ink is preferably from 5 wt. % to 10 wt. %.

A smaller proportion of carbon nanotubes leads to the resulting ink being too low-viscosity and thus possibly no longer suitable for high throughput printing processes such as e.g. screen printing. A higher proportion of carbon nanotubes also increases the viscosity beyond the level that would still appear meaningful for the ink to be used in printing processes.

Aqueous formulation in connection with the present invention refers to a composition in which the solvent consists predominantly of water, the ink preferably containing over 50 wt. %. The ink particularly preferably contains at least 80 wt. % water.

The high content of water as solvent is advantageous since this means that the ink is acceptable from the point of view of industrial hygiene with respect to the solvent, both in the printing process and after application.

The at least one polymeric dispersing agent is generally at least one agent selected from the series of: water-soluble homopolymers, water-soluble random copolymers, water-soluble block copolymers, water-soluble graft polymers, particularly polyvinyl alcohols, copolymers of polyvinyl alcohols and polyvinyl acetates, polyvinyl pyrrolidones, cellulose derivatives such as e.g. carboxymethyl cellulose, carboxypropyl cellulose, carboxymethyl propyl cellulose, hydroxyethyl cellulose, starch, gelatine, gelatine derivatives, amino acid polymers, polylysine, polyaspartic acid, polyacrylates, polyethylene sulfonates, polystyrene sulfonates, polymethacrylates, polysulfonic acids, condensation products of aromatic sulfonic acids with formaldehyde, naphthalene sulfonates, lignin sulfonates, copolymers of acrylic monomers, polyethyleneimines, polyvinylamines, polyallylamines, poly(2-vinylpyridines), block copolyethers, block copolyethers with polystyrene blocks and polydiallyldimethylammonium chloride.

The at least one polymeric dispersing agent is preferably at least one agent selected from the series of: polyvinyl pyrrolidone, block copolyethers and block copolyethers with polystyrene blocks, carboxymethyl cellulose, carboxypropyl cellulose, carboxymethyl propyl cellulose, gelatine, gelatine derivatives and polysulfonic acids.

Most particularly preferably, polyvinyl pyrrolidone and/or block copolyethers with polystyrene blocks are used as polymeric dispersing agents. Particularly suitable polyvinyl pyrrolidone has a molecular weight Mₙ in the range of 5000 to 400,000. Suitable examples are PVP K15 from Fluka (molecular weight about 10000 amu) or PVP K90 from Fluka (molecular weight of about 360000 amu) or block copolyethers with polystyrene blocks, with 62 wt. % C₂ polyether, 23 wt. % C₃ polyether and 15 wt. % polystyrene, based on the dried dispersing agent, with a ratio of the block lengths of C₂ polyether to C₃ polyether of 7:2 units (e.g. Disperbyk 190 from BYK-Chemie, Wesel).

The at least one polymeric dispersing agent is preferably present in the ink in a proportion of 0.01 wt. % to 10 wt. %, preferably in a proportion of 0.1 wt. % to 7 wt. %, particularly preferably in a proportion of 0.5 wt. % to 5 wt. %.

The generally used and preferred polymeric dispersing agents are advantageous particularly in the proportions stated since, in addition to supporting a suitable dispersing of the carbon nanotubes, they also allow an adjustment of the viscosity of the ink according to the invention as well as an adjustment of surface tension and film formation and adhesion of the ink to the respective substrate.

Inks according to the invention generally have a dynamic viscosity of at least 0.5 Pa.s, preferably of 1 to 200 Pa.s.

This viscosity of the ink makes them particularly suitable for use in high throughput printing processes, such as screen printing, for example. Compositions with a much lower viscosity generally lead to running of the ink on the surfaces to which it is applied in the aqueous ink formulations, and thus to a poor printed image. This is of particular importance in the printing of electrical traces for switching circuits.

In addition to the at least one polymeric dispersing agent, in a preferred development of the novel ink, the ink can also comprise at least one conductive salt.

The at least one conductive salt in this case is preferably selected from the list of salts with the cations: tetraalkylammonium, pyridinium, imidazolium, tetraalkylphosphonium, and as anions various ions from simple halide via more complex inorganic ions such as tetrafluoroborates to large organic ions such as trifluoromethanesulfonimide are employed.

The adding of at least one conductive salt to the ink according to the invention is advantageous because these salts possess a negligible vapour pressure and are conductive. Thus, the salt is available as a film-forming agent and a conductive agent even at elevated temperatures and under reduced pressure. Particularly in the context of the printing process taking place, it may therefore be possible to prevent the printed image from running.

In another development of the novel ink, the ink may additionally comprise a proportion of carbon black together with the proportions of carbon nanotubes and polymeric dispersing agent.

In connection with the present invention, carbon black refers to fine particles of elemental carbon in graphite or amorphous form. Fine particles in this context are particles with an average diameter of less than or equal to 1 μm.

If according to the development carbon black is added to the ink according to the invention, this is preferably carbon black as obtainable from EVONIC under the name Printex®PE.

The addition of a proportion of carbon black to the ink is advantageous because with only a slight further increase in viscosity, the conductivity of the printed image to be obtained from the ink can be increased further in that potential voids between the carbon nanotubes are filled with carbon black, as a result of which the conductive connection between the carbon nanotubes is established and thus the conductive cross section of the printed image is increased.

The present invention also provides a process for the preparation of a printable composition for the production of conductive coatings based on carbon nanotubes and at least one polymeric dispersing agent in an aqueous formulation, particularly of a printable composition according to the invention, characterised in that it comprises at least the following steps:
a) optional oxidative pretreatment of the carbon nanotubes,
b) preparation of an aqueous pre-dispersion by dissolving the polymeric dispersing agent in an aqueous solvent, and the input and distribution of carbon nanotubes in the resulting solution,
c) input of a volume-based energy density, preferably in the form of shear energy, of at least 10⁴ J/m³, preferably of at least 10⁵ J/m³, particularly preferably 10⁷ to 10⁹ J/m³ into the pre-dispersion until the agglomerate diameter of the carbon nanotube agglomerates is substantially ≦5 μm, preferably ≦3 μm, particularly preferably ≦2 μm.

Should a pretreatment of the carbon nanotubes, according to step a) of the process according to the invention, take place, which is preferred, the pretreatment generally takes place by treating with an oxidizing agent.

The pretreatment with an oxidizing agent advantageously takes place preferably in that the carbon nanotubes are dispersed in a 5 to 10 wt. % aqueous solution of the oxidizing agent, and then the carbon nanotubes are separated out of the oxidizing agent and subsequently dried. The dispersing in an oxidizing agent generally takes place for a period of one to 12 h. The carbon nanotubes are preferably dispersed in the oxidizing agent for a period of 2 h to 6 h, particularly for about 4 h. The separation of carbon nanotubes from the oxidizing agent generally takes place by sedimentation. The separation preferably takes place by sedimentation under the earth's gravity or by sedimentation in a centrifuge. The drying of the carbon nanotubes generally takes place in ambient air and at temperature of 60° C. to 140° C., preferably at temperatures of 80° C. to 100° C.

The oxidizing agent is generally nitric acid and/or hydrogen peroxide; the oxidizing agent is preferably hydrogen peroxide.

The preparation of the aqueous pre-dispersion according to step b) of the novel process advantageously takes place by dissolving the at least one polymeric dispersing agent in an initial charge of water, and then adding carbon nanotubes.

According to a preferred development of the invention, organic solvents, preferably selected from the series of: C₁ to C₅ alcohol, particularly C₁ to C₃ alcohol, ethers, particularly dioxalane, and ketones, particularly acetone, may also be added to the water.

According to a preferred development of the novel ink, it is also possible to add carbon black and/or conductive salts in the context of step b) of the novel process.

The addition of carbon nanotubes can take place together with the at least one polymeric dispersing agent or consecutively. Preferably the at least one polymeric dispersing agent is added first and then the carbon nanotubes are added in batches. Particularly preferably the addition of the at least one dispersing agent and then the addition of the carbon nanotubes in batches take place with stirring and/or with ultrasound treatment.

If, according to the preferred developments of the novel ink, this ink comprises conductive salts and/or carbon black, the carbon black is preferably added together with the carbon nanotubes in the same way and/or the conductive salts are added together with the at least one polymeric dispersing agent in the same way.

The consecutive and batchwise addition of carbon nanotubes with stirring and/or ultrasound for the preparation of the pre-dispersion is particularly advantageous, since this allows an improvement in the dispersing of the carbon nanotubes to achieve the finished ink, in which the carbon nanotubes are present in a form that is stable towards sedimentation and thus the input of energy into the pre-dispersion needed according to step c) of the process according to the invention can be reduced.

According to a preferred development of step b) of the process according to the invention, after the addition of at least one polymeric dispersing agent and the addition of carbon nanotubes, at least one conductive salt is also added.

The input of the volume-based energy density, e.g. in the form of shear energy, into the pre-dispersion according to step c) of the novel process particularly preferably takes place by passing the pre-dispersion at least once through a homogenizer. In this process, the volume-based energy density can be introduced into the pre-dispersion e.g. in the area of the nozzle orifice. All embodiments known to the person skilled in the art, such as e.g. high pressure homogenizers, are suitable as homogenizers. Particularly suitable high-pressure homogenizers are known in principle e.g. from the document Chemie Ingenieur Technik, Volume 77, Issue 3 (pp. 258-262). Particularly preferred homogenizers are high-pressure homogenizers; most particularly preferred high-pressure homogenizers are jet dispersers, gap homogenizers and high-pressure homogenizers of the Microfluidizer® type.

The pre-dispersion is preferably passed at least twice through a homogenizer, preferably a high-pressure homogenizer. Particularly preferably the pre-dispersion is passed at least three times through a homogenizer, preferably a high-pressure homogenizer.

The multiple passes through a homogenizer, preferably a high-pressure homogenizer, are advantageous because any coarse agglomerates of the carbon nanotubes remaining are comminuted by this process, as a result of which the ink is improved in its physical properties, such as e.g. viscosity and conductivity. By adjusting the input pressure and the automatically resulting adjustment of the gap width of the homogenizer, the maximum size of any agglomerates remaining can be influenced in a targeted manner.

This economic optimum is achieved when less than 15 number % of the carbon nanotubes of the ink are still present as agglomerates of ≦10 μm, which approximately corresponds to three passes of the pre-dispersion through the homogenizer, preferably the high-pressure homogenizer.

The homogenizer, preferably the high-pressure homogenizer, is generally a jet disperser or a gap homogenizer, which is operated with an input pressure of at least 50 bar and an automatically adjusted gap width.

The homogenizer, preferably the high-pressure homogenizer, is preferably operated with an input pressure of 1000 bar and an automatically adjusted gap width. Most particularly preferred are high-pressure homogenizers of the Micronlab type.

The alternative, equally preferred embodiment of steps b) and c) of the novel process provides the treatment of the pre-dispersion in a triple roll mill.

The preferred process is characterised in that the preparation of the pre-dispersion b) and the input of shear energy c) take place by a treatment of the pre-dispersion in a triple roll mill with rotating rolls, the process comprising at least the following steps:
b1) introduction of the solution of the polymeric dispersing agent in the aqueous solvent together with the carbon nanotubes into a first gap between a first and a second roll with different rates of rotation, wherein the carbon nanotubes are pre-dispersed in the solution and coarse agglomerates are comminuted;
b2) transport of the pre-dispersion from step b1) to a second gap between the second roll and a third roll with a different rate of rotation, the pre-dispersion at least partly adhering to the roll surface during transport;
c1) introduction of the pre-dispersion into the second gap, wherein the agglomerates of the carbon nanotubes in the dispersion are comminuted to a diameter of substantially ≦5 μm, preferably ≦3 μm, particularly preferably ≦2 μm;
c2) removal of the finished dispersion from the roll surface of the third roll.

The alternative embodiment of the process according to the invention is preferably operated in such a way that the ratio of the rate of rotation of the first roll and the second roll and the ratio of the rate of rotation of the second roll and the third roll are, independently of one another, at least 1:2, preferably at least 1:3.

The width of the gap between the first and second roll and between the second and third roll may be the same or different. The gap width is preferably the same. The gap width is particularly preferably the same and less than 10 μm, preferably less than 5 μm, particularly preferably less than 3 μm.

It is particularly advantageous to carry out the alternative steps b) and c) of the novel process because, as a result of the different rates of rotation of the rolls of the same diameter, high shear rates are achieved in the first and second gaps, which permit good dispersion of the carbon nanotubes. Particularly in combination with the preferred equal, small gap widths, the result is very advantageous. By means of the alternative embodiment of step c), it is possible to obtain inks with small proportions of agglomerates and small agglomerate sizes. In preferred embodiments, the adjustment of the gap in the homogenizer, preferably the high-pressure homogenizer, is regulated by the adjustment of the input pressure such that this is comparable to the adjustment of the gap between the rolls in the triple roll mill. In preferred embodiments, the passage through the two gaps in the triple roll mill can approximately correspond to two passes in the homogenizer, preferably the high-pressure homogenizer.

The inks according to the invention obtained according to the process according to the invention and its preferred and alternative embodiments are particularly suitable for use e.g. in screen printing, offset printing or similar, generally known, high throughput processes for the production of conductive printed images.

The invention also provides an electrically conductive coating obtainable by printing, particularly by means of screen printing or offset printing of the composition according to the invention on to a surface and removal of the solvent or solvents.

The invention also provides an object with surfaces of non-conductive or poorly conductive material (surface resistance of less than 10⁴ Ohm.m) exhibiting a coating obtainable from the composition according to the invention.

In a development of the use of the ink according to the invention, the conductive printed image of the ink can optionally be thermally post-treated.

The thermal post-treatment of the printed ink takes place in the context of its use preferably by drying at a temperature from room temperature (23° C.) to 150° C., preferably 30° C. to 140° C., particularly preferably 40° C. to 80° C.

A thermal post-treatment is advantageous if the adhesion of the ink according to the invention to the substrate can be improved thereby and the printed ink can thereby be secured against slurring.

In addition to the good conductivity of the printed images of the inks according to the invention and their preferred developments, the novel inks also possess other properties which may be advantageous for other applications.

For example, it is generally known that the group of substances of the carbon nanotubes and also the special carbon nanotubes used according to the invention have particularly high strength. It is therefore conceivable using the ink according to the invention, by applying the same on to a surface, to transfer the positive mechanical properties of the special carbon nanotubes on to the surface, at least in part.

Moreover, carbon nanotubes, as obtained e.g. according to the disclosure of U.S. patent application Ser. No. 12/208,468, are characterised by particular ratios of length to diameter (so-called aspect ratios). For the inks according to the invention, the possibility thus arises of exposing the printed images obtained to further mechanical loads in the form of deforming stress (e.g. by thermoforming, if the surface consists of a polymer material), without the carbon nanotubes losing contact with one another and thus the printed images losing conductivity, as the carbon nanotubes align themselves along the direction of stress.

The invention will now be described in further detail with reference to the following non-limiting examples.

### EXAMPLES

### Example 1

### Preparation of the Catalyst

A solution of 0.306 kg Mg(NO₃)₂*6H₂O in water (0.35 litres) was mixed with a solution of 0.36 kg Al(NO₃)₃*9H₂O in 0.35 l water. 0.17 kg Mn(NO₃)₂*4H₂O and 0.194 kg Co(NO₃)₂*6H₂O, each dissolved in 0.5 l water, were then added and the entire mixture was brought to a pH value of approx. 2 by adding nitric acid while stirring for 30 min. A stream of this solution was mixed with 20.6 wt. % sodium hydroxide solution in a ratio of 1.9:1 in a mixer and the resulting suspension was added to a charge of 5 l water. The pH value of the charge was kept at approx. 10 by controlling the addition of sodium hydroxide solution.

The precipitated solid was separated from the suspension and washed several times. The washed solid was then dried within 16 h in a paddle dryer, the temperature of the dryer being increased from ambient temperature to 160° C. within the first eight hours. The solid was then ground in a laboratory mill to an average particle size of 50 μm and the middle fraction in the range of 30 μm to 100 μm particle size was removed to facilitate the subsequent calcining, especially to improve fluidising in the fluidised bed and to achieve a high product yield. The solid was then calcined for 12 hours in an oven at 500° C. with air admission and then cooled for 24 hours. The catalyst material was then left to stand for a further 7 days for post-oxidation at room temperature. A total of 121.3 g of catalyst material was isolated.

### Example 2

### Preparation of the CNTs in a Fluidised Bed

The catalyst prepared in Example 1 was tested in fluidised bed apparatus on a laboratory scale. For this purpose, a defined quantity of catalyst was placed in a steel reactor with an internal diameter of 100 mm heated externally by a heat transfer medium. The temperature of the fluidised bed was regulated by means of PID regulation of the electrically heated heat transfer medium. The temperature of the fluidised bed was determined by a thermoelement. Starting gases and inert diluting gases were fed into the reactor by means of electronically controlled mass flow regulators.

The reactor was first rendered inert with nitrogen and heated up to a temperature of 650° C. A quantity of 24 g of catalyst 1 according to Example 1 was then metered in.

The starting gas was then switched on immediately as a mixture of ethene and nitrogen. The volume ratio of the starting gas mixture was ethene:N₂=90:10. The overall volume flow was adjusted to 40 LN·min⁻¹. The passing of the starting gases over the catalyst took place for a period of 33 minutes. The running reaction was then terminated by interrupting the starting product feed and the reactor contents were removed.

### Example 3

25 g of the carbon nanotubes prepared in accordance with Example 2 were initially charged in 250 g water. At RT, 334 g 10% H₂O₂ were added to this dropwise within 1.15 h. A slight generation of gas occurred and the temperature rose to 29° C. This mixture was then stirred for a further 4 h at RT and left to stand overnight so that the carbon nanotubes could settle. The supernatant was then decanted. The sedimented carbon nanotubes were washed twice with water and then dried at 60° C. until constant mass was reached. The agglomerates were smaller than 200 μm after this pre-dispersion.

Ten times, 0.5 g each time of the oxidised carbon nanotubes were dispersed in 95 g of a 2% aqueous PVP40 solution (from SIGMA-ALDRICH) in succession for 3 min each time using an ultrasound finger (G. Heinemann, Ultraschall und Labortechnik) at an amplitude of 30% of the maximum output. The entire dispersion was then treated for a further 6 min with the ultrasound finger, 40% amplitude. This sample was treated with a high-pressure homogenizer (Gaulin Micron Lab, AVP Gaulin GmbH) in three passes at 1000 bar pressure difference each time for the purpose of further dispersion. The particles were smaller than 3 μm after this dispersion. The viscosity of the dispersion at a shear rate of 1/s was 1.68 Pa.s.

The resulting paste was applied through a screen (Heinen, Cologne-Pulheim) on to polycarbonate (Macrolon®, Bayer Material Science AG) and dried at RT. The conductivity of the printed images obtained is then determined. It is 3*10³ S/m.

Photographs of the coating under a transmission electron microscope show that the agglomerates of the carbon nanotubes have a diameter of 1 μm and less.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An aqueous, printable composition comprising carbon nanotubes and a polymeric dispersing agent, wherein at least one fifth of the carbon nanotubes have a molecular structure comprising a plurality of stacked and rolled graphene layers.

2. The composition according to claim 1, wherein the at least one fifth of the carbon nanotubes have an average length to external diameter ratio of more than 5.

3. The composition according to claim 1, wherein the at least one fifth of the carbon nanotubes have an average external diameter of 3 to 100 nm.

4. The composition according to claim 1, wherein at least a portion of the at least one fifth of the carbon nanotubes are present as agglomerates having of no more than 5 μm.

5. The composition according to claim 1, wherein all carbon nanotubes comprise 0.1 wt. % to 15 wt. % of the composition.

6. The composition according to claim 1, wherein the at least one fifth of the carbon nanotubes are oxidatively pretreated.

7. The composition according to claim 1, wherein the polymeric dispersing agent comprises one or more components selected from the group consisting of water-soluble homopolymers, water-soluble random copolymers, water-soluble block copolymers, water-soluble graft polymers, cellulose derivatives, amino acid polymers, polyacrylates, polyethylene sulfonates, polystyrene sulfonates, polymethacrylates, polysulfonic acids, condensation products of aromatic sulfonic acids with formaldehyde, naphthalene sulfonates, lignin sulfonates, copolymers of acrylic monomers, polyethyleneimines, polyvinylamines, polyallylamines, poly(2-vinylpyridines), block copolyethers, block copolyethers with polystyrene blocks, polydiallyldimethylammonium chloride, and mixtures thereof.

8. The composition according to claim 1, wherein the polymeric dispersing agent comprises one or more components selected from the group consisting of polyvinyl alcohols, copolymers of polyvinyl alcohols and polyvinyl acetates, polyvinyl pyrrolidones, carboxymethyl cellulose, carboxypropyl cellulose, carboxymethyl propyl cellulose, hydroxyethyl cellulose, starch, gelatine, gelatine derivatives, polylysine, polyaspartic acid, and mixtures thereof.

9. The composition according to claim 1, wherein the polymeric dispersing agent comprises 0.01 wt. % to 10 wt. % of the composition.

10. The composition according to claim 1, further comprising an organic solvent.

11. The composition according to claim 10, wherein the organic solvent comprises one or more compounds selected from the group consisting of alcohols, ethers, ketones, dioxalane, and mixtures thereof.

12. The composition according to claim 1, wherein the composition has a dynamic viscosity of at least 0.5 Pa.s.

13. A process comprising: (i) providing a polymeric dispersing agent; (ii) providing carbon nanotubes, wherein at least one fifth of the carbon nanotubes have a molecular structure comprising a plurality of stacked and rolled graphene layers; (iii) combining the polymeric dispersing agent, the carbon nanotubes and an aqueous medium to form an aqueous, printable composition.

14. The process according to claim 13, further comprising an oxidative pretreatment of the carbon nanotubes.

15. The process according to claim 14, wherein the oxidative pretreatment comprises treatment with an oxidizing agent selected from the group consisting of HNO₃, H₂O₂, and mixtures thereof.

16. The process according to claim 13, wherein combining the polymeric dispersing agent, the carbon nanotubes and an aqueous medium comprises:
preparing an aqueous predispersion wherein the polymeric dispersing agent is dissolved in the aqueous medium to provide a solution and the carbon nanotubes are added to the solution, the aqueous predispersion comprising agglomerates of the carbon nanotubes; and
subjecting the aqueous predispersion to a a volume-based energy density of at least 10⁴ J/m³ until the carbon nanotube agglomerates have an average agglomerate diameter of ≦5 μm.

17. The process according to claim 14, wherein combining the polymeric dispersing agent, the carbon nanotubes and an aqueous medium comprises:
preparing an aqueous predispersion wherein the polymeric dispersing agent is dissolved in the aqueous medium to provide a solution and the carbon nanotubes are added to the solution, the aqueous predispersion comprising agglomerates of the carbon nanotubes; and
subjecting the aqueous predispersion to input of a volume-based energy density of at least 10⁴ J/m³ until the carbon nanotube agglomerates have an average agglomerate diameter of ≦5 μm.

18. The process according to claim 16, wherein subjecting the aqueous predispersion to the input of a volume-based energy density comprises passing the predispersion through a homogenizer.

19. The process according to claim 16, wherein preparing the aqueous predispersion and subjecting the aqueous predispersion to the input of a volume-based energy density are carried out in a triple roll mill having a first roll, a second roll, a third roll, a first gap between the first roll and the second roll, and a second gap between the second roll and the third roll, each of the rolls having a surface and a rate of rotation; the process further comprising:
introducing the solution and the carbon nanotubes into the first gap, the rates of rotation of the first roll and the second roll being different, wherein the carbon nanotubes are pre-dispersed in the solution and coarse agglomerates are comminuted to provide the predispersion;
transporting the predispersion to the second gap;
introducing the predispersion into the second gap, the rates of rotation of the second roll and the third roll being different, wherein agglomerates of the carbon nanotubes are comminuted to an average agglomerate diameter of ≦5 μm to form a finished dispersion; and
removing the finished dispersion from the surface of the third roll.

20. The process according to claim 19, wherein the first gap and the second gap each independently have a width of less than 10 μm.

21. The process according to claim 19, wherein the triple roll mill has a ratio of first roll rate of rotation to second roll rate of rotation of at least 1:2, and independently, a ratio of second roll rate of rotation to third roll rate of rotation of at least 1:2.

22. A method comprising providing a aqueous, printable composition according to claim 1, and subjecting the composition to a high-throughput printing process to provide an electrically conductive printed image.

23. An electrically conductive coating prepared by the method according to claim 22.

24. An article comprising a substrate having a surface, wherein the surface is at least partially coated with an electrically conductive coating according to claim 23.
